(19) United States
(12) Patent Application Publication
(10) Pub. No.: US 2014/0140260 A1
(43) Pub. Date: May 22, 2014

(54) METHOD AND APPARATUS FOR INITIATING MBMS SERVICE RECEPTION STATUS REPORT

(71) Applicants: He Wang, Shanghai (CN); Chandrika Worrall, Newbury (GB)

(72) Inventors: He Wang, Shanghai (CN); Chandrika Worrall, Newbury (GB)

(73) Assignee: ALCATEL LUCENT, Paris (FR)

(21) Appl. No.: 14/115,155

(22) PCT Filed: Apr. 25, 2012
(86) PCT No.: PCT/IB2012/000932

§ 371 Date: Feb. 3, 2014

(30) Foreign Application Priority Data
May 2, 2011 (CN) 201110114742.3

(51) Int. Cl. H04W 36/00; H04W 4/06

(52) U.S. Cl. CPC H04W 36/0016; H04W 4/06
USPC 370/312

(57) ABSTRACT

A method and an apparatus for initiating a Multimedia Broadcast/Multicast Service (MBMS) service reception status report are disclosed in the present invention. The method includes: a User Equipment (UE) automatically obtaining its MBMS service reception status information, wherein the MBMS service reception status information at least includes a service identification of an MBMS service being received by the UE; sending the MBMS service reception status information of the UE, which can be used by the base station to make a decision for the UE handover, to a base station. According to the invention, an initiating mechanism for initiating an MBMS service reception status report by the UE autonomously is provided, therefore providing the MBMS service reception status information for a network to make End a decision for the UE handover, while keeping a good continuity of the MBMS service possibly. Moreover, a method, an apparatus, a UE and a base station for performing the UE handover decision are also disclosed in the embodiments of the present invention.

### FIELD OF THE INVENTION

The present invention relates to the Multimedia Broadcast/Multicast Service (MBMS) technology, and more specifically, to a method and apparatus for initiating an MBMS service reception status report.

### BACKGROUND OF THE INVENTION

The 3^{rd} Generation Partnership Project (3GPP) has defined the MBMS service and published a set of MBMS specifications. An MBMS service is a technology of point to multi-point service for sending data from one data source to a plurality of users, so as to achieve the sharing of web resources. A typical MBMS service includes mobile phone advertisement, mobile phone music station, mobile stock, contingency control system, video program etc, for example. Recently, the 3GPP Long Term Evolution (3GPP LTE) technology Rel-9 and further releases also support enhanced Multimedia Broadcast/Multicast Service (eMBMS).

In a mobile communication network, considering the mobility of User Equipments (UEs) connecting a Radio Resource Control (RRC), handover is commonly directed by the network. Generally, a UE sends a measurement report (including signal quality information etc, for example) to an E-UTRAN (evolved Universal Terrestrial Radio Access Network), for example, according to a pre-determined reporting rule. The E-UTRAN will make a handover decision on target cell selection based on this measurement report, so as to direct the UE to a proper target cell as fast as possible. However, for example, for an MBMS service, it is very important for the RRC-connected UE to keep service reception continuity. However, it is not sufficient at all to ensure a good continuity of MBMS service using only the information in the measurement report.

To this end, there is a need in this art for a solution to keep the continuity of MBMS service reception.

### SUMMARY OF THE INVENTION

In view of this, the invention discloses a mechanism for initiating an MBMS service reception status report, so as to provide a feasible way to address or at least mitigate the above problems.

According to one aspect of the invention, there is provided a method for initiating an MBMS service reception status report. The method includes: obtaining MBMS service reception status information of a User Equipment (UE) autonomously at the UE, the MBMS service reception status information at least including a service identification of an MBMS service being received by the UE; and sending the UE's MBMS service reception status information to a base station, so as to be used by the base station when making a decision relating to handover of the UE.

In an embodiment according to the invention, the UE's MBMS service reception status information is sent to the base station by means of measurement report signaling of the UE by including the MBMS service reception status information into the measurement report signaling.

In another embodiment according to the invention, the UE's MBMS service reception status information is sent to the base station through a separate Radio Resource Control (RRC) message.

In still another embodiment according to the invention, the method further includes: monitoring the UE's MBMS service reception status, and wherein the MBMS service reception status information is obtained and generated and further sent to the base station only when a change of the UE's MBMS service reception status is monitored.

In another embodiment according to the invention, the UE's MBMS service reception status information further includes service identification of an MBMS service that the UE wants to receive. Optionally, the MBMS service reception status information further includes MBSFN area information corresponding to the MBMS service. Further optionally, the MBMS service reception status information further includes priority order information for indicating the UE's interesting level to an MBMS service.

According to a second aspect of the invention, there is provided a method for making a decision relating to handover of a User Equipment (UE). The method includes: receiving MBMS service reception status information of the UE sent by the UE; and making a decision relating to the handover of the UE based on the UE's MBMS service reception status information.

According to a third aspect of the invention, there is provided an apparatus for initiating an MBMS service reception status report. The apparatus includes: status information obtaining means configured to obtain MBMS service reception status information of a User Equipment (UE) autonomously at the UE, the MBMS service reception status information at least including a service identification of an MBMS service being received by the UE; and status information sending means configured to send the UE's MBMS service reception status information to a base station, so as to be used by the base station when making a decision relating to handover of the UE.

According to a fourth aspect of the invention, there is provided an apparatus for making a decision relating to handover of a User Equipment (UE). The apparatus includes: status information receiving means configured to receive MBMS service reception status information of the UE sent by the UE; and make a decision relating to the handover of the UE based on the UE's MBMS service reception status information.

According to a fifth aspect of the invention, there is provided a user equipment which includes the apparatus according to the third aspect of the invention.

According to a sixth aspect of the invention, there is provided a base station which includes the apparatus according to the fourth aspect of the invention.

According to embodiments of the invention, there is mainly provided an initiating mechanism for initiating an MBMS service reception status report by the UE autonomously, thus the UE's MBMS service reception status information may be provided for making a decision relating to the handover of the UE. Therefore, a feasible way is provided to keep a good continuity of the MBMS service reception of the UE. According to other embodiments, the decision relating to the handover of the UE may be made at a base station based on the MBMS service reception status. Since the UE's MBMS service reception status has been taken into account, it is possible to select an optimal target cell according to the UE's MBMS service reception status.

### BRIEF DESCRIPTION OF THE DRAWINGS

The above and other features of the invention will become more apparent through the detailed description of the embodiments in conjunction with the accompanying drawings within which the same reference numbers are used to represent the same or the similar elements. Within the accompanying drawings:

FIG. 1A illustrates a flow chart of a method for initiating an MBMS service reception status report according to an embodiment of the invention;

FIG. 1B illustrates a flow chart of a method for initiating an MBMS service reception status report according to another embodiment of the invention;

FIG. 2 illustrates a diagram of a basic signaling procedure for sending MBMS service reception status information according to an embodiment of the invention;

FIG. 3 illustrates a diagram of a basic signaling procedure for sending MBMS service reception status information according to another embodiment of the invention;

FIG. 4 illustrates a flow chart of a method for making a handover decision for the UE according an embodiment of the invention;

FIG. 5 illustrates a block diagram of an apparatus for initiating an MBMS service reception status report according to another embodiment of the invention; and

FIG. 6 illustrates a block diagram of an apparatus for making a handover decision for the UE according to an embodiment of the invention.

### DETAILED DESCRIPTION OF THE INVENTION

Before describing the embodiments of the invention in details, some necessary explanations are set out. Flow charts and block diagrams are illustrated in accompanying drawings to show systematic architectures, functions and operations that may be implemented according to systems, methods and program products of various embodiments of the invention. In this regard, each block in flow charts or block diagrams may represent a module, a program segment, or a part of codes, said module, program segment, or part of codes including one or more executable instructions for implementing specified logical functions. Also should notice that in some alternative implementations, the functions marked in the blocks may proceed in a sequence different from those in the accompanying drawings. For example, two blocks represented successively can be substantially performed basically in parallel, and sometimes may be performed in inverse sequence, depending on the functions related. Also should notice that each block in flow charts and/or block diagrams and combinations of blocks in flow charts and/or block diagrams may be implemented using systems dedicated for performing specified functions or operations, or be implemented using combinations of dedicated hardware and instructions.

In the following, the mechanism for initiating an MBMS service reception status report provided by the invention will be described in details through embodiments in connection with accompanying drawings.

In the process for research of the MBMS technology, the inventors realized that it is not sufficient to ensure a good continuity of MBMS service reception for a RRC-connected UE during the handover of the UE by using only the information in a measurement report. Moreover, the inventors also realized that in order to keep the continuity of MBMS service reception for the UE, it is necessary to consider the UE is current MBMS service reception status when making a decision on selection of a target cell.

In eMBMS of Rel-10, a counting mechanism for a single MBMS service has been defined for the operator to collect the user statistical information about certain MBMS service and to control transmission of the MBMS service by turning MBSFN mode on or off in the whole MBSFN area. In this case, the UEs will feed back their reception status about that service according to the requirement of the network. It occurred to inventors' mind that the reception status information may potentially be used to perform handover. However, after a deep research, it is found that there're still some problems when using this mechanism to obtain UE's reception status information.

Firstly, the mechanism is with respect to service instead of UE, i.e. what is provided by the mechanism is statistical information of the user number for some particular services but not the current service reception status information for particular UEs that can be used when making handover decision. In order to obtain the service reception status information for particular UEs, statistics of all possible MBMS services is required. Resource consumption for this is relatively large and the efficiency is low.

In addition, it is not mandatory for this mechanism that all the MBMS services should require their UEs to feed back their reception status. That means for some MBMS services, corresponding UEs would not report their MBMS service reception status to the network. Therefore, in this case, it may be unable to obtain the reception status information of related services, thereby unable to obtain the MBMS service reception status information of some UEs to perform an optimized handover decision on target cell selection.

Moreover, the service reception status obtained based on this mechanism is the service reception status during the statistics, but not the service reception status during the handover. Therefore, such service reception status information is not suitable to make the handover decision related to target cell selection which has certain timeliness requirement.

Any of the above problems makes it difficult to obtain MBMS service reception status information for a UE by means of the statistical mechanism in the eMBMS of the current Rel-10. However, there is neither an MBMS service reception status report mechanism on purpose of handover decision in the eMBMS of the current Rel-10. Therefore, in the eMBMS of Rel-11, we need to design an MBMS service reception status report mechanism required by UE handover decision for the continuity of MBMS service reception, such that a base station can obtain UE's MBMS service reception status information. And for the purpose of continuity of MBMS service reception, the UE's MBMS service reception status information is used in target cell handover selection to select a proper target cell. To this end, the present invention proposes a mechanism for initiating an MBMS service reception status report autonomously by the UE, which will be described in details in the following through embodiments with reference to the accompanying drawings.

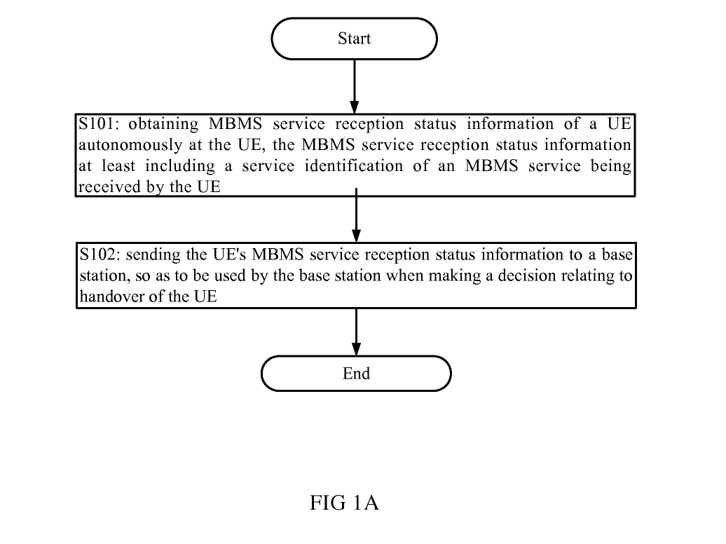

Firstly, refer to FIG. 1A, which illustrates a flow chart of method for initiating an MBMS service reception status report according to an embodiment of the invention.

As shown in FIG. 1A, at step S101, MBMS service reception status information for a UE is autonomously obtained at the UE. The MBMS service reception status information at least includes a service identification of MBMS service being received by the UE.

When a RRC-connected UE, for example, is moving and a handover is taking place, in order to keep the reception continuity of the MBMS service for the UE, a base station need to obtain the UE's MBMS service reception status before making a handover decision. Therefore, the base station may use the UE's MBMS service reception status in the target cell selection for handover preparation for the UE so as to keep the continuity of the MBMS service.

To this end, the UE's MBMS service reception status information may be obtained automatically or autonomously at the UE such that it may send its MBMS service reception status information to the base station before the base station making a handover decision. The UE should autonomously report its MBMS service reception status to the base station in advance, because the UE's MBMS service reception status depends highly on interests at particular times. However this can not be controlled by the base station.

In order to provide the base station with information useful for handover decision, the MBMS service reception status information should at least include the service identification of the MBMS service being received by the UE. To keep the continuity of the MBMS service for the UE, The base station at least needs to know the MBMS service being received by the UE. Only in this manner, the base station is able to select for the UE a target cell which may provide corresponding MBMS service as much as possible, no matter the MBMS is provided only at one frequency or multiple frequencies.

In an embodiment of the invention, the MBMS service reception status information may also include the service identification of an MBMS service that the UE wants to receive, i.e. information of the services that the UE is interested in. However these services may be provided at one frequency or multiple frequencies (if it is known by the UE). In this manner, when making a handover decision, the services that the user is interested in may be considered so that the user's interest may be satisfied after handing over to the target cell.

Generally speaking, the base station is not required to use detailed MBMS service configuration information when making a handover decision and target cell selection. However in some cases, the UE may simultaneously be interested in several MBMS services and/or receive several MBMS services. Furthermore, in some cases, one MBMS service may be transmitted in multiple MBSFN areas. Whereas, the candidate target cells may also belong to different MBSFN areas from that of the current serving cell. So it is beneficial if the UE's MBMS service reception status information further includes information of the MBSFN area to which the current cell belongs. This may provide the base station with a larger flexibility and improve the successful rate in handover preparation. To this end, in another embodiment of the invention, the UE's MBMS service reception status information may also include the MBSFN area information corresponding to the MBMS service.

Furthermore, the UE may simultaneously be interested in several MBMS services and/or receive several MBMS services, but not all candidate target cells may meet all service requirements of the UE. For this case, the base station may choose for the UE the service requirements needed to be met randomly or according to other predetermined rules. However, this may not indicate the UE's true requirements. Therefore, it will be beneficial if the UE can provide priority order information to indicate the UE's interesting levels to respective MBMS services. To this end, the UE's MBMS service reception status information further includes priority order information to indicate the UE's interesting levels to respective MBMS services. The priority order information may be a priority order value indication for particularly indicating the priority sequence of each service. The priority order value indication of each service may be implicitly indicated by the sequence of each service in the service list. So that when the base station makes a handover decision, it furthest considers the UE's interesting and directs the UE to a cell which can provide service with the highest priority.

It should be noted that, the contents in the above given in the MBMS service reception status information is only illustrative, and the MBMS service reception status information may include any other information that may help keeping the continuity of the MBMS service reception.

Next, in step S102, the UE's MBMS service reception status information may be sent to the base station for use by the base station when making a handover decision for the UE.

After the UE's MBMS service reception status information is obtained, it may be sent to the base station.

It is known that the UE will measure its received signal quality and report the measured signal quality to the serving base station eNB according to the network configuration information including signal including signal qualities of UE's serving cell and neighboring cells. Then the eNB uses this measurement report to make the handover decision and target cell selection for this UE. This means that, before each handover, the UE needs to send the measurement report to the network and wait for a network decision for handover preparation. Therefore, the UE's MBMS service reception status report and the UE's measurement report may be bound together. Thus, the eNB can obtain the UE's MBMS service reception status information before it performs the handover decision and target cell selection.

To this end, according to an embodiment of the invention, the UE's MBMS service reception status information is transmitted to the base station by means of a measurement report signaling of the UE by including the MBMS service reception status information into the measurement report signaling.

In order to be compatible with a UE without MBMS service capability at the meanwhile, the MBMS service reception status information may be designed to be an optional information for the measurement report. Thus, when the eNB decodes the measurement report, the newly added information element may be ignored in Rel 9/10. On the other hand, there may also be UEs that have the MBMS service reception capabilities but are not receiving MBMS services currently. For this case, it is beneficial to design the MBMS service reception status information to be an optional information.

Furthermore, an independent Radio Resource Control (RRC) message may be newly defined to send the UE's MBMS service reception status information to the base station through a separate RRC message. In this case, the UE's MBMS service reception status information should at least be sent to the base station before a predetermined time period is elapsed after the measurement report is sent by the UE, and more preferably before the measurement report is sent by the UE.

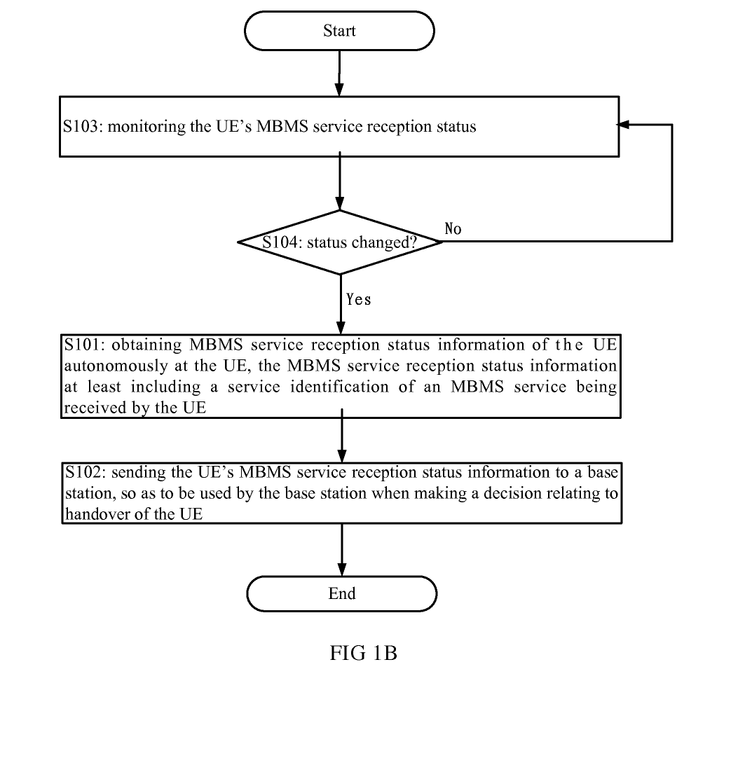

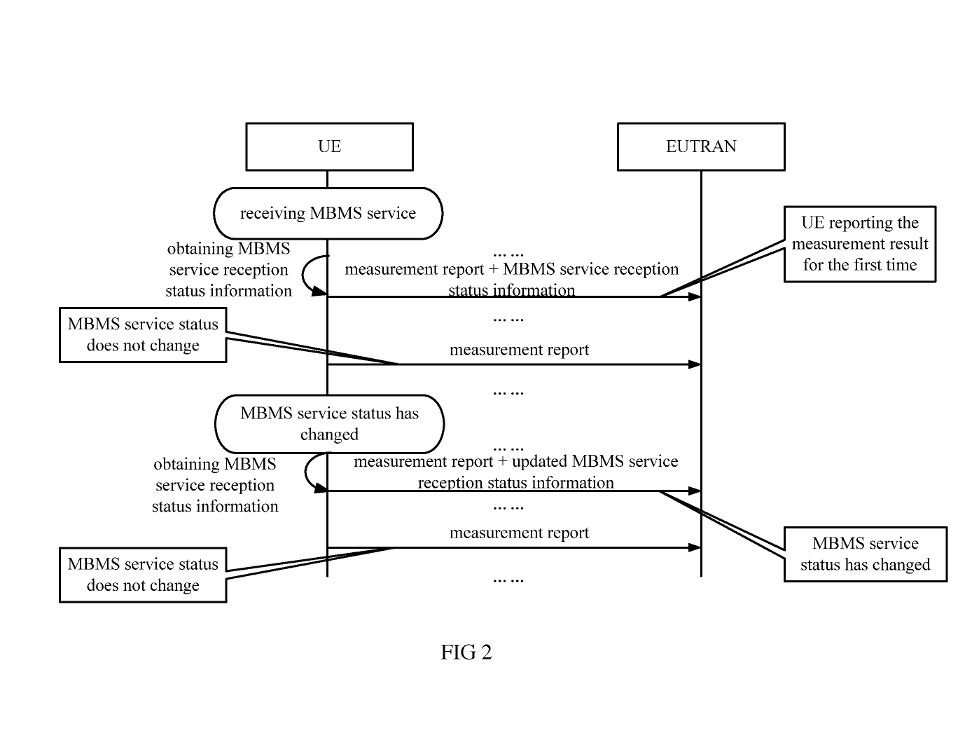

The above method for sending the MBMS service reception status information will be described in detail with reference to FIGS. 2 and 3 hereinafter, so it will not be described herein.

Furthermore, FIG. 1B illustrates a method for initiating an MBMS service reception status report according to another embodiment of the invention. With reference to 1B, the difference from the method in FIG. 1A lies in that steps S103 and S104 are included before steps S101 and S102. At step 103, the UE's MBMS service reception status is monitored. For example it is monitored the beginning of a new MBMS service, the stop of an existing MBMS service, the change of an MBMS service and so on. Next, at step S104, it is determined whether current MBMS service reception status has changed. Steps S101 and S102 are performed only when a change of the UE's MBMS service reception status is monitored (for example, beginning/stopping some MBMS service receptions, or changing interests to some services). Compared with the method in FIG. 1A, the method in FIG. 1B may further reduce resource consumption.

Next, two exemplary methods for sending MBMS service reception status information will be described with reference to FIG. 2 and FIG. 3.

Firstly, refer to FIG. 2, which illustrates a diagram of a basic signaling procedure for sending MBMS service reception status information according to an embodiment of the invention, wherein the MBMS service reception status information is sent by means of the UE's measurement report.

As mentioned above, before each handover, the UE needs to send the measurement report to the base station and wait for the network decision for the handover preparation. The time property for sending the UE's measurement report provides a chance to send the UE's MBMS service reception status report. Therefore the UE's MBMS service reception status report and the UE's measurement report may be bound together.

In order to send the UE's MBMS service reception status information to the base station through the measurement report, for example, an additional information element (IE) may be defined in the measurement report. For example, “mbmsReceptionStatus-r11” may be defined in the “MeasurementReport” message of RRC protocol TS36.331. For purpose of illustration, a modified measurement report message is presented hereinafter. However it is to be noted that this is only exemplary, and those skilled in this are may design different forms of messages under the teaching herein.

### Example of a Modified Measurement Report

Measurement message

-- ASN1START
MeasurementReport ::= SEQUENCE {

| | |
|---|---|
| criticalExtensions | CHOICE { |
| c1 | CHOICE{ |
| measurementReport-r8 | MeasurementReport-r8-IEs, |
| mbmsRecptionStatus-r11 | MBMSReceptionStatus-r11-IEs, |

```
    OPTIONAL
          spare7 NULL,
          spare6 NULL, spare5 NULL, spare4 NULL,
          spare3 NULL, spare2 NULL, spare1 NULL
      },
```

| | |
|---|---|
| criticalExtensionsFuture | SEQUENCE { } |
| } | |
| } | |

MeasurementReport-r8-IEs ::= SEQUENCE {

| | | |
|---|---|---|
| measResults | MeasResults, | |
| nonCriticalExtension | MeasurementReport-v8a0-IEs | OPTIONAL |
| } | | |

MeasurementReport-v8a0-IEs ::= SEQUENCE {

| | | |
|---|---|---|
| lateNonCriticalExtension | OCTET STRING | OPTIONAL, |
| nonCriticalExtension | SEQUENCE { } | |
| OPTIONAL | | |
| } | | |

MBMSReceptionStatus-r11-IEs ::= SEQUENCE (SIZE(1..maxMBSFN−Area)) OF
ReceptionStatusPerMBSFNArea-r11
ReceptionStatusPerMBSFNArea-r11 ::= SEQUENCE {

| | |
|---|---|
| mbsfn-AreaIndex-r11 | INTEGER (0..7) |

```
    receivedServiceListPerMbsfnArea-r11
    ReceivedServiceListPerMbsfnArea-r11,
}
```

| | |
|---|---|
| ReceivedServiceListPerMbsfnArea-r11 ::= | SEQUENCE (SIZE 1.. |

maxSessionPerPMCH*maxPMCH−PerMBSFN))

OF MBMSServiceInfo-r11

```
MBMSServiceInfo-r11 ::= SEQUENCE {
    mbmsServiceId TMGI-r9,
    InterestPriority INTEGER (0..7) OPTIONAL
}
-- ASN1STOP
```

In the example of the modified measurement report as shown, bold characters shows the newly added information element “mbmsReceptionStatus-r11”. In addition, as shown in this example, this IE is an optional IE so as to allow a UE measurement report without the MBMS service reception status information. This is because there may be UEs without MEMS capabilities or UEs that have the MBMS service reception capabilities but are not receiving MBMS services. Furthermore, considering the forward compatibility, when a new measurement report information is received and decoded by a Rel 9/10 eNB, the newly added Rel-11 IE may be ignored by the Rel 9/10 eNB.

It should be noted that in the example shown, the priority order information is represented explicitly, i.e. priority order values are used as priority order indications. However, the invention is not limited to this, and the priority order information also may be represented implicitly. For example, the priority order value of each service may be implicitly indicated by the sequence of service identifications in the MBMS service information list. This approach has no impact on detailed signalling design. What is only needed is that the UE should arrange the sequence of service identifications in the service list according to priority orders when generating measurement report. Thus, the priority order may be implicitly indicated only by predefining the sequence of service identifications in the service list to be ascending or descending. This also needs to be standardized in the RRC protocols, because the RRC protocols will direct the UE's message generation process and the eNB's message decoding process.

As shown in FIG. 2, for a UE which is receiving MBMS services, the obtained MBMS service reception status may be included in the measurement report when the UE sends the measurement report to the base station via the EUTRAN for the first time, so as to be sent to the base station together with the measurement report.

Then, if no change is occurred to the MBMS service reception status, this means that the current MBMS service reception status is identical to the MBMS reception status information sent to the base station previously. Thus, in order to reduce redundant information and save system resources, it may only send the measurement report itself when sending the measurement report. Then, when a change is occurred to the UE's MBMS service reception status, the MBMS service reception status information will be obtained and included in the measurement report so as to be sent to the base station. Of course, it may also be possible to send the current MBMS service reception status to the base station each time the measurement report is to be sent no matter whether the UE's MBMS service reception status has changed. In this manner, the MBMS service reception status may be sent to the base station for use by the base station when making handover decision.

Furthermore, FIG. 3 illustrates a diagram of a basic signaling procedure for sending MBMS service reception status information according to another embodiment of the invention, wherein the MBMS service reception status information is sent based on a separate RRC message.

Another solution to send MBMS service reception status information is to define a new RRC message. For purpose of illustration, an example of a newly defined MBMS service reception status report message is presented hereinafter. However it is to be noted that this is only exemplary, and those skilled in this are may design different forms of messages under the teachings herein.

### Example of an MBMS Service Reception Status Report Message

MBMSReceptionStatusReport message

-- ASN1START
MBMSReceptionStatusReport ::= SEQUENCE {

| | |
|---|---|
| mbmsReeptionStatus-r11 | MBMSReceptionStatus-r11-IEs, |
| } | |

MBMSReceptionStatus-r11-IEs ::= SEQUENCE SIZE(1..maxMBSFN−Area)) OF
ReceptionStatusPerMBSFNArea-r11
ReceptionStatusPerMBSFNArea-r11 ::= SEQUENCE {

| | |
|---|---|
| mbsfn-AreaIndex-r11 | INTEGER (0..7) |
| ReceivedServiceListPerMbsfnArea-r11 | ReceivedServiceListPerMbsfnArea-r11, |
| } | |

ReceivedServiceListPerMbsfnArea-r11 ::= SEQUENCE (SIZE (1..
maxSessionPerPMCH*maxPMCH−PerMBSFN))

OF MBMSServiceInfo-r11

MBMSServiceInfo-r11 ::= SEQUENCE {
mbmsServiceId TMGI-r9,
InterestPrionty INTEGER (0..7) OPTIONAL
}
-- ASN1STOP

As shown in FIG. 3, in order to ensure the UE's MBMS service reception status report may be used for handover decisions, the UE needs to send its MBMS to the base station before the handover decision. Therefore, the UE may send its MBMS service reception status report to the network before sending its measurement report for the first time. Of course, the UE's MBMS service reception status report may also be sent before a predetermined time period is elapsed after the measurement report is sent, as long as the predetermined time period is negotiated with the base station beforehand. The predetermined time period should be chosen according to actual situations, but it can not be too long, because this will cause the time period for decision too long. Then, if the UE's MBMS service reception status doesn't change, the UE needs not to send its MBMS service reception status report. If the UE's MBMS service reception status changes, for example, beginning/stopping some MBMS service receptions, or changing interests to some services, the UE may immediately send the MBMS service reception status information to the base station through the RRC message (for example, at the optional timing 1 as shown in FIG. 3). The UE may also send the MBMS service reception status information to the base station before the next closest measurement report (for example, at the optional timing 2 as shown in FIG. 3). Furthermore, the UE may also send the MBMS service reception status information at any time before the predetermined time period (which is negotiated with the base station beforehand) is elapsed after the measurement report is sent (for example, at the optional timing 3 as shown in FIG. 3). Thus, the UE's MBMS service reception status in the base station may be updated for use by the base station when making handover decisions.

It can be seen from above that compared with the technical solutions based on the measurement report, the technical solution based on a separate RRC, which may send the updated service reception status information at any suitable time without the constraint of the measurement report, is more flexible in term of triggering timing of the sending of MBMS service reception status report. This is because the measurement report will only be sent at particular times, while the separate RRC message may be sent at any suitable time independent on the measurement report. Moreover, this may also enable the base station to obtain updated information more timely and use the updated information for handover preparation.

It also should be noted that similar to the example for the modified measurement report as shown above, in the newly defined MBMS service reception status report message, a technical solution for indicating priority order explicitly is presented as an example. However, those skilled in this art may understand that the priority order may be implicitly indicated using the sequence of the service identifications in the service message list.

Moreover, it is different from the technical solution based on the measurement report in that only the UE that is receiving the MBMS service or the UE that wants to report to the network that it is interested in some MBMS services and will potentially receive these services subsequently will send the RRC message; whereas the UE without an MBMS capability or the UE that has the MBMS capability but does not want to receive any MBMS service will not send this message. Therefore, in this sense, the information element “MeasurementReport” defined in the RRC message is mandatory instead of optional.

Furthermore, in the above two technical solutions, the procedures for the UE to generate the MBMS service reception status information IE or the RRC message are similar. Once the triggering condition for the UE to initiate the MBMS reception status report is met, the UE will check/obtain the status of the MBMS service it is receiving or interested in and generate corresponding IE or RRC message. Then the UE sends the corresponding measurement including the MBMS service reception status information or the RRC message including corresponding MBMS reception status report. Moreover, considering the UE has different interest priority orders to different services, related priority order value will be set to indicate the priority order of each service explicitly, or the sequence of the service information will be arranged implicitly with an ascending or descending sequence according to the priority order of each service.

According to the aforementioned embodiments, there is provided an initiating mechanism for initiating an MBMS service reception status report by the UE independently, thus MBMS service reception status information may be provided for a network to make a decision relating to the handover of the UE. Therefore, a feasible way is provided to keep a good continuity of MBMS service reception.

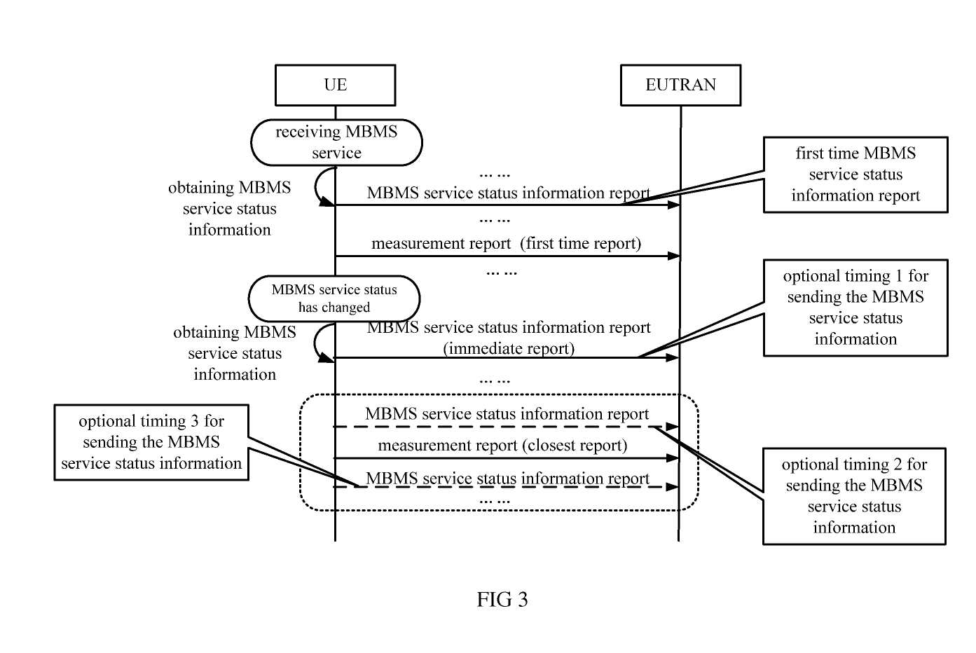

Furthermore, FIG. 4 illustrates a flow chart of a method for making a decision relating to the handover of the UE according to an embodiment of the invention.

As shown in FIG. 4, firstly, at step S401, the MBMS service reception status information sent by the UE is received.

No matter whether the MBMS service reception status report is sent via the measurement report or via a separate RRC message, the processing of the base station eNB to the reports is the same. The eNB will parse the corresponding service reception status information from the report and preserve the information for the UE into its context, to keep tracking of the UE's MBMS service reception status.

Next, at step S402, a decision relating to the handover of the UE is made based on the UE's MBMS service reception status information.

To make the handover decision for the UE, the eNB will choose a suitable cell as the target cell based on the UE's current MBMS service reception status and the MBMS service reception statuses of candidate target cells. Meanwhile, the eNB may also consider the signal quality and the match between the MBMS service supply in the target cell and the services received by the UE synthetically.

It is substantial implementation of handover strategy to choose a suitable target cell for the UE based on these information. Those skilled in this art may implement various different embodiments according to the teaching here, thus it is not described in detail herein.

In this manner, the decision relating to the handover of the UE may be made at the base station based on the MBMS service reception status. Since the UE's MBMS service reception status is taken into account when making the decision related to the handover, an optimal target cell may be selected with regard to the UE's MBMS service reception status, so as to keep the continuity of the MBMS service reception for the UE as much as possible.

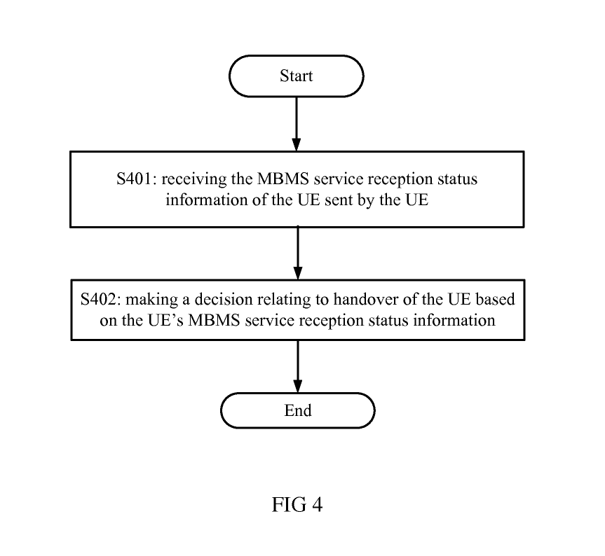

Furthermore, FIG. 5 illustrates a block diagram of an apparatus for initiating an MBMS service reception status report according another embodiment of the invention.

As shown in FIG. 5, apparatus 500 may include: status information obtaining means 501 and status information sending means 502. The status information obtaining means 501 is configured to obtain MBMS service reception status information of a UE automatically at the UE. The MBMS service reception status information at least includes a service identification of an MBMS service being received by the UE. The status information sending means 502 is configured to send the UE's MBMS service reception status information to a base station, so as to be used by the base station when making a decision relating to the handover of the UE.

According to an embodiment of the invention, the status information sending means 501 is configured to send the UE's MBMS service reception status information to the base station by means of a measurement report signaling of the UE by including the MBMS service reception status information into the measurement report signaling. Alternatively, the MBMS service reception status information is optional for the measurement report signaling.

According to another embodiment of the invention, the status information sending means 501 is configured to send the UE's MBMS service reception status information to the base station through a separate Radio Resource Control (RRC) message. Alternatively, the status information sending means 501 is configured to send the UE's MBMS service reception status information to the base station at least before a predetermined time period is elapsed after the measurement report is sent by the UE.

According to an embodiment of the invention, the MBMS service reception status information further includes the service identification of an MBMS service that the UE wants to receive. Alternatively, the MBMS service reception status information further includes MBSFN area information corresponding to the MBMS service. Further alternatively, the MBMS service reception status information further includes priority order information for indicating the UE's interesting level to an MBMS service.

According to another embodiment of the invention, the apparatus 500 is operated for a RRC-connected UE.

Moreover, alternatively, the apparatus 500 further includes reception status monitoring means 503 configured to monitor the UE's MBMS service reception status. In this embodiment, the status information obtaining means 501 will obtain and generate the UE's MBMS service reception status information and the status information sending means 502 will send the MBMS service reception status information to the base station only when a change of the UE's MBMS service reception status is monitored.

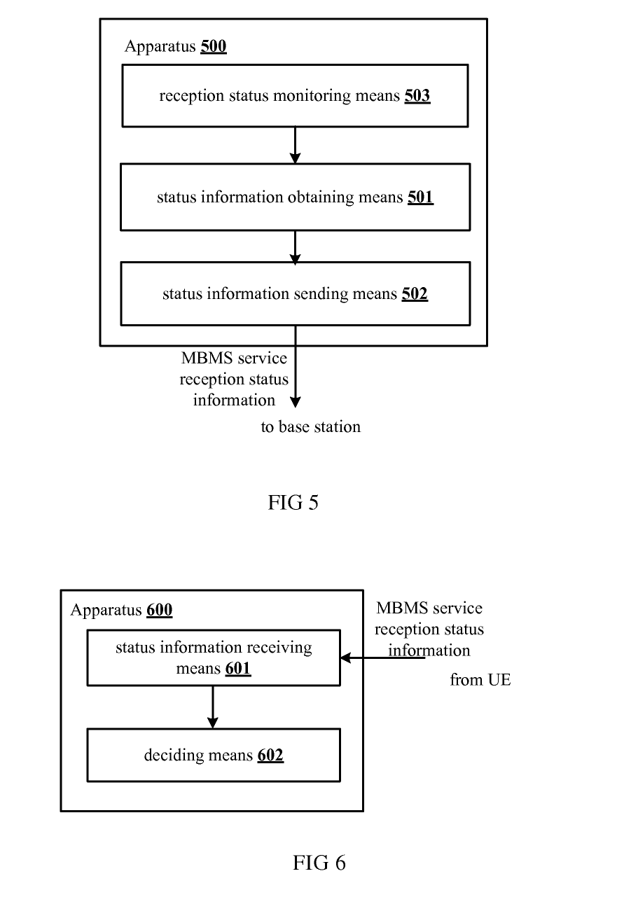

FIG. 6 illustrates a block diagram of an apparatus for making a decision relating to the handover of the UE according to an embodiment of the invention. The apparatus 600 includes: status information receiving means 601 configured to receive MBMS service reception status information of the UE sent by the UE; and deciding means 602 configured to make a decision relating to the handover of the UE based on the MBMS service reception status information.

It should be noted that the operation of each part of apparatus 500 and apparatus 600 described with reference to FIG. 5 and FIG. 6 substantially corresponds to each step of the methods aforementioned. Therefore, the specific operation of these parts may refer to the specific descriptions of the methods of the invention described with reference to FIG. 1 and FIG. 4.

Furthermore, the invention provides a User Equipment (UE) which includes the aforementioned apparatus for initiating an MBMS service reception status report according to the invention, such as the apparatus 500.

The invention further provides a base station which includes an apparatus for making a decision relating to the handover of a UE according to the invention, such as the apparatus 600.

Furthermore, it should be noted that the embodiments of the invention may be implemented in software, hardware or the combination of software and hardware. The hardware part may be implemented by using dedicated logics; and the software part may be stored in a memory and performed by a suitable instruction executing system such as a micro processor or a dedicated design hardware. Those skilled in this art may understand that the abovementioned methods and systems may be implemented using computer executable instructions and/or by including them into processor controlled codes. For example, such codes may be provided on carrier media such as magnetic disk, CD or DVD-ROM, programmable memory such as read only memory (firmware) or data carriers such as optical signal and electronic signal carriers. The system and its components of this embodiment may be implemented for example by hardware circuits such as super large integrated circuits or gate arrays, semiconductors such as logic chips and transistors, or programmable hardware devices such as field programmable gate arrays or programmable logic device, or may be implemented by various types of processor executable software, or may be implemented by the combination of the abovementioned hardware circuits and software.

Although the invention has been described with reference to currently considered embodiments, it should be understood that the invention is not limited to the disclosed embodiments. On the contrary, the invention intends to cover various changes and equivalent arrangements within the sprit and scope contained by the appended claims. The scope of the append claims accord to the widest interpretation so as to contain all these changes and equivalent structures and functions.

1. A method for initiating a Multimedia Broadcast/Multicast Service (MBMS) service reception status report, comprising:
obtaining MBMS service reception status information of a User Equipment (UE) automatically at the UE, the MBMS service reception status information at least including a service identification of an MBMS service being received by the UE; and
sending the UE's MBMS service reception status information to a base station, so as to be used by the base station when making a decision relating to handover of the UE.

2. The method according to claim 1, wherein the UE's MBMS service reception status information is sent to the base station by means of measurement report signaling of the UE by including the MBMS service reception status information into the measurement report signaling.

3. (canceled)

4. The method according to claim 1, wherein the UE's MBMS service reception status information is sent to the base station through a separate Radio Resource Control (RRC) message.

5. The method according to claim 4, wherein the UE's MBMS service reception status information is sent to the base station at least before a pre-determined time period is elapsed after the measurement report is sent.

6. The method according to claim 1, further comprising:
monitoring the UE's MBMS service reception status, and
wherein the MBMS service reception status information is obtained and generated and further sent to the base station only when a change of the UE's MBMS service reception status is monitored.

7. (canceled)

8. (canceled)

9. The method according to claim 1, wherein the UE's MBMS service reception status information further includes priority order information for indicating the UE's interesting level to an MBMS service.

10. (canceled)

11. A method for making a decision relating to handover of a User Equipment (UE), comprising:
receiving a Multimedia Broadcast/Multicast Service (MBMS) service reception status information of the UE sent by the UE; and
making a decision relating to the handover of the UE based on the UE's MBMS service reception status information.

12. An apparatus for initiating a Multimedia Broadcast/Multicast Service (MBMS) service reception status report, comprising:
status information obtaining means configured to obtain MBMS service reception status information of a User Equipment (UE) autonomously at the UE, the MBMS service reception status information at least including a service identification of an MBMS service being received by the UE; and
status information sending means configured to send the UE's MBMS service reception status information to a base station, so as to be used by the base station when making a decision relating to handover of the UE.

13. The apparatus according to claim 12, wherein the status information sending means is configured to send the UE's MBMS service reception status information to the base station by means of measurement report signaling of the UE by including the MBMS service reception status information into the measurement report signaling.

14. (canceled)

15. The apparatus according to claim 12, wherein the status information sending means is configured to send the UE's MBMS service reception status information to the base station through a separate Radio Resource Control (RRC) message.

16. The apparatus according to claim 15, wherein the status information sending means is configured to send the UE's MBMS service reception status information to the base station at least before a predetermined time period is elapsed after the measurement report is sent.

17. The apparatus according to claim 12, further comprising:
reception status monitoring means configured to monitor the UE's MBMS service reception status, and wherein,
the status information obtaining means obtains and generates the MBMS service reception status information and the status information sending means sends the MBMS service reception status information to the base station only when a change of the UE's MBMS service reception status is monitored.

18. (canceled)

19. (canceled)

20. The apparatus according to claim 12, wherein the MBMS service reception status information further includes priority order information for indicating the UE's interesting level to an MBMS service.

21. (canceled)

22. An apparatus for making a decision relating to handover of a User Equipment (UE) comprising:
status information receiving means configured to receive a Multimedia Broadcast/Multicast Service (MBMS) service reception status information of the UE sent by the UE; and
deciding means configured to make a decision relating to the handover of the UE based on the UE's MBMS service reception status information.

23. (canceled)

24. (canceled)
